(19) United States
(12) Patent Application Publication
(10) Pub. No.: US 2015/0134148 A1
(43) Pub. Date: May 14, 2015

(54) FLOOR CLEANING OR BURNISHING MACHINE WITH POINTING DEVICES

(71) Applicant: NSS Enterprises, Inc., Toledo, OH (US)

(72) Inventors: Dale A. Krausnick, Perrysburg, OH (US); Jeffery R. Felihauer, Toledo, OH (US)

(21) Appl. No.: 14/603,463

(22) Filed: Jan. 23, 2015

Related U.S. Application Data
(63) Continuation-in-part of application No. 13/874,581, filed on May 1, 2013.
(60) Provisional application No. 62/081,082, filed on Nov. 18, 2014.
(60) Provisional application No. 61/641,932, filed on May 3, 2012.

(51) Int. Cl. A47L 11/40; A47L 11/28

(52) U.S. Cl. CPC A47L 11/4066; A47L 11/4061; A47L 11/28
USPC 701/2; 701/22

(57) ABSTRACT

A floor cleaning or burnishing machine has at least one motor controller electrically connected to a pointing device control, right and left software driven motor control logic units, an electrical power source, and right and left electrical drive motors. These motors are mechanically connected to respective rear steering drive wheels. Rotational speed and direction of each rear wheel is independently controlled, using the pointing device in cooperation with respective control logic units, in either a forward or reverse direction. At any given time, each control logic unit controls a respective motor controller which individually controls the rotational speed and direction of a respective wheel, thereby each wheel is capable of rotating in an opposite direction at a different speed to the other wheel. To slow the machine down, regenerative braking is utilized by operating the motors as generators.

### RELATED APPLICATION

This application claims the benefit under 35 U.S.C. §119(e), of U.S. Provisional Patent Application Ser. No. 61/641,932, filed May 3, 2012 under 35 U.S.C. §111(b), and under 35 U.S.C. §119(e), of U.S. Provisional Patent Application Ser. No. 62/081,082, filed Nov. 18, 2014, under 35 U.S.C. §111(b), and is a continuation in part application of and claims benefit under 35 U.S.C. §120, of pending U.S. patent application Ser. No. 13/874,581, filed May 1, 2013, which applications are incorporated herein in their entirety.

### FIELD OF THE INVENTION

The present invention relates to a floor cleaning or burnishing machine and, more particularly, to precise control of a floor cleaning or burnishing machine with a pointing device.

### BACKGROUND OF THE INVENTION

Currently, floor cleaning machines and, in particular, battery powered automatic floor cleaning machines are either walk behind or ride-on type of machines. Floor cleaning machines have many functions including vacuuming, sweeping, buffing, stripping, scrubbing and carpet cleaning. Generally, battery powered automatic floor cleaning machines that are applied in the floor care industry are typically utilized to maintain flooring in large areas.

Although these types of machines are utilized to maintain large floor areas, these vehicles need to be maneuverable while navigating in tight areas and around obstacles. Also, due to their heavy usage, these vehicles should be easy to operate without causing undo stress or strain on an operator.

In general, battery powered automatic floor cleaning machines are comprised of a movable frame/body for carrying a brushing means, reservoirs for storing fresh and spent cleaning liquids, a means for dispensing fresh cleaning liquid onto the floor, and a vacuum pick-up system for recovering spent cleaning liquid from the floor.

Most walk behind machines are battery powered and comprise a frame that is supported by drive wheels and casters for moving the frame, a motor that drives the wheels, casters that aid the drive wheels to steer and also to support the frame above of the floor, and a speed control that is used to operate the drive motor. Further, a throttle may be provided that is generally hand operated and connected to the speed control, wherein the speed control can be configured in one of two ways: a) open ended, meaning that the throttle moves in one direction controlling the speed of the drive motor with a direction switch that is needed for controlling the direction (forward or reverse) of the drive motor, and b) wig-wag speed control, meaning the throttle is moved back and forth in two directions while controlling both speed and direction of the drive motor.

Steering on a walk behind machine is generally accomplished by an operator moving a handle bar, located at the rear of the machine, left or right, thereby pointing the machine in the operator's walking direction. However, maneuvering the floor cleaning machine in this manner can be difficult and fatiguing for the operator.

Most ride-on machines are battery powered which comprise a frame supported by a pair of wheels in the back and a front drive wheel(s) for moving the frame, a motor for driving the front wheel(s), and a speed control for operating the drive motor. In this case, the throttle is generally foot operated and connected to the speed control. Like the walk behind, the ride-on machine's speed control can also be configured in one of two ways, a) open ended and b) a wig-wag speed control, much like that detailed above for the walk behind machines.

Ride-on floor cleaning machines normally further comprise a steering wheel or handle bar coupled to the front drive wheel that moves on the floor. By rotating the steering wheel or handle bar, the operator selects the desired direction, thereby steering the machine. This also can be difficult and fatiguing for the operator who typically needs to maneuver the floor cleaning machine into small tight areas.

One means of controlling a floor cleaning machine is through the use of a joystick. Originally, joysticks were used with cables for mechanically controlling ailerons and elevators on some of the first airplanes. More recently, joystick type controls have been applied to control heavy equipment, cranes, marine vessels, lawn equipment, video games, and cleaning machines.

U.S. Pat. No. 7,730,980 to Mayer et al., hereinafter Mayer, discloses another means of controlling a cleaning machine that uses independently driven drive wheels and casters, where a steering system, such as a steering wheel or handle bar, is coupled to the frame. Also, this cleaning machine may have a separate control system that is either hand or foot operated, for controlling the speed and forward or reverse direction of the machine. The steering system, when pivoted around an axis, sends a signal to the controller that speeds up or slows down the driven drive wheels allowing the machine to change direction from left to right. The Mayer system is, however, limited by its drive control because the operator still has two machine controls, those being a steering member and a throttle to control the machine. Also, the maneuverability of the machine is limited by pivoting around on a single axis by the wheels.

U.S. Pat. No. 7,041,029 to Fulghum et al., hereinafter Fulghum, teaches yet another means for controlling a cleaning machine, which is to use a drive system with a powered front wheel steering system. In this patent, a joystick system provides forward and reverse speed signals to the drive system and an input to the powered front wheel steering system for controlling the direction of the front wheel so as to allow for the cleaning machine to turn left or right. Hence, the Fulghum cleaning machine uses the directional front wheel to steer the machine along the floor, wherein the sharper the steering angle the lower the maximum traverse speed.

Still, there is a need for a floor cleaning/burnishing machine that more accurately controls the speed and steering of a ride-on, battery operated floor cleaning/burnishing machine, so as to more precisely maneuver and navigate during cleaning and burnishing, thereby saving operator time and cleaning chemical costs. It would further be advantageous if such a machine would not require the operator to use two hands to control such a floor cleaning/burnishing machine.

Therefore, what is sought is a cleaning/burnishing machine that provides easy one hand operation or no hand operation of an automatic floor cleaning machine while being highly maneuverable and easy to navigate in tight areas and around obstacles, while reducing operator fatigue, by way of a variety of pointing devices. It would also be advantageous to utilize a more direct mechanism for driving the wheels and to more precisely control the steering.

### SUMMARY OF THE INVENTION

A floor cleaning or burnishing machine has at least one motor controller that can be electrically connected to a variety of pointing devices, while utilizing software driven motor control logic to individually steer and drive the machine right and left, and forward and reverse. The floor cleaning or burnishing machine also has an electrical power source, and individual right and left electrical drive motors. The right drive motor is mechanically connected to a right rear steering drive wheel and the left electrical drive motor is mechanically connected to a left rear steering drive wheel. Rotational speed and direction of each rear steering drive wheel is independently controlled, by way of the pointing devices in cooperation with the respective right and left or forward and reverse software driven control logic, in a full range of directions. At any given time, the right/left or forward/reverse software driven control logic controls a single or respective motor controllers which individually control the rotational speed and direction (i.e., velocity) of a respective rear drive wheels, thereby each rear drive wheel is capable of rotating in an opposite direction at a different speed to the other drive wheel.

### BRIEF DESCRIPTION OF THE DRAWINGS

The advantages of the present invention will become readily apparent to those skilled in the art from the following detailed description when considered in light of the accompanying drawings, in which:

FIG. 1 is an isometric view from the right rear of a first floor cleaning/burnishing machine in accordance with the present invention;

FIG. 1A is an isometric view from the right rear of a second floor cleaning/burnishing machine in accordance with the present invention;

FIG. 1B is an isometric view from the right front of a third floor cleaning/burnishing machine in accordance with the present invention;

FIG. 2 is a first electrical control schematic for controlling the floor cleaning/burnishing machines of FIGS. 1, 1A, and 1B having a first embodiment with software driven motor control logic units in contact with two motor controllers;

FIG. 2A is a second electrical control schematic for controlling the floor cleaning/burnishing machines of FIGS. 1, 1A, and 1B having a second embodiment with software driven motor control logic units in contact with one motor controller and separate direct drive mechanisms for each wheel;

FIG. 3 is a diagrammatic view of basic pointing device directions A-P and ST for the floor cleaning/burnishing machine of FIG. 1, 1A, or 1B;

FIG. 4 is a top view of the floor cleaning/burnishing machine of FIG. 1, 1A, or 1B operated in direction ST;

FIG. 5 is a top view of the floor cleaning/burnishing machine of FIG. 1, 1A, or 1B operated in direction A;

FIG. 6 is a top view of the floor cleaning/burnishing machine of FIG. 1, 1A, or 1B operated in direction I;

FIG. 7 is a top view of the floor cleaning/burnishing machine of FIG. 1, 1A, or 1B operated in direction M;

FIG. 8 is a top view of the floor cleaning/burnishing machine of FIG. 1, 1A, or 1B operated in direction E;

FIG. 9 is a top view of the floor cleaning/burnishing machine of FIG. 1, 1A, or 1B operated in direction C;

FIG. 10 is a top view of the floor cleaning/burnishing machine of FIG. 1, 1A, or 1B operated in direction K;

FIG. 11 is a top view of the floor cleaning/burnishing machine of FIG. 1, 1A, or 1B operated in direction O;

FIG. 12 is a top view of the floor cleaning/burnishing machine of FIG. 1, 1A, or 1B operated in direction G;

FIG. 13 is a top view of the floor cleaning/burnishing machine of FIG. 1, 1A, or 1B operated in direction B;

FIG. 14 is a top view of the floor cleaning/burnishing machine of FIG. 1, 1A, or 1B operated in direction P;

FIG. 15 is a top view of the floor cleaning/burnishing machine of FIG. 1, 1A, or 1B operated in direction H;

FIG. 16 is a top view of the floor cleaning/burnishing machine of FIG. 1, 1A, or 1B operated in direction J;

FIG. 17 is a top view of the floor cleaning/burnishing machine of FIG. 1, 1A, or 1B operated in direction D;

FIG. 18 is a top view of the floor cleaning/burnishing machine of FIG. 1, 1A, or 1B operated in direction N;

FIG. 19 is a top view of the floor cleaning/burnishing machine of FIG. 1, 1A, or 1B operated in direction F;

FIG. 20 is a top view of the floor cleaning/burnishing machine of FIG. 1, 1A, or 1B operated in direction L;

FIG. 21 is a third electrical control schematic for controlling the floor cleaning/burnishing machines of FIGS. 1, 1A, and 1B having either the first or the second embodiments with software driven motor control logic units in contact with one motor controller;

FIG. 22 is a logic diagram of motor operations utilizing pointing devices, in accordance with the present invention;

FIG. 23 is an electrical schematic of the electrical connection to the internal circuit of the motor controllers; and

FIG. 24a is a three dimensional isometric view of a mouse with right and left control buttons and a scroll wheel;

FIG. 24b is a three dimensional isometric view of a stylus with a hand held touch screen device;

FIG. 24c is a three dimensional isometric view of a tablet with a virtual keyboard;

FIG. 24d is a three dimensional isometric view of a track ball;

FIG. 24e is a three dimensional isometric view of a hand held remote control ring;

FIG. 24f is a three dimensional isometric view of a light pen;

FIG. 24g is a three dimensional isometric view of a Google glass;

FIG. 24h is a three dimensional isometric view of a laptop computer with a keyboard, touch pad, and screen;

FIG. 24i is a three dimensional isometric view of a remote RF controller;

FIG. 24j is a three dimensional isometric view of a smartphone;

FIG. 24k is a three dimensional isometric view of a blue tooth wireless mouse; and

FIG. 24l is a three dimensional isometric view of a touch pad with right and left control buttons, and right and left scroll buttons.

Further advantages will be apparent from the following description and appended claims, reference being made to the accompanying drawings forming a part of a specification, wherein like reference characters designate corresponding parts of several views.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

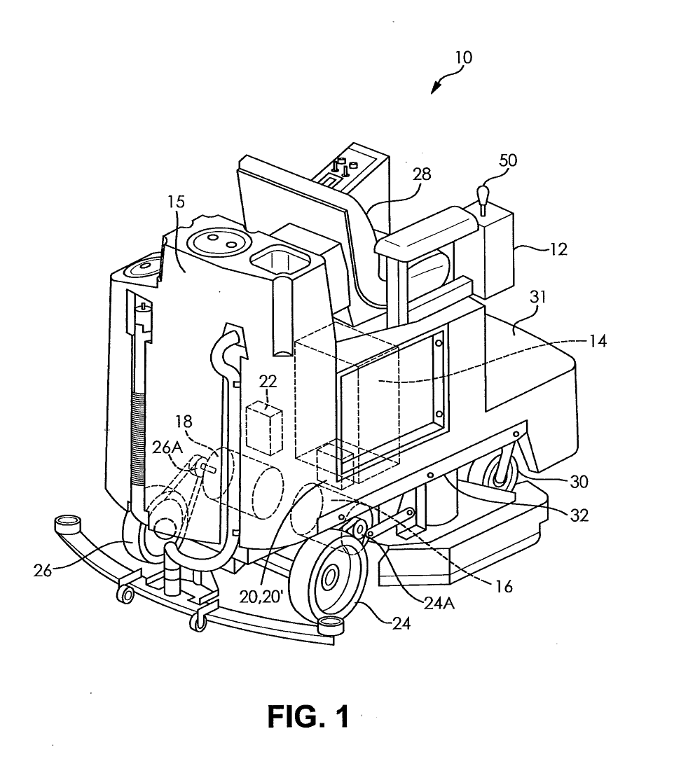

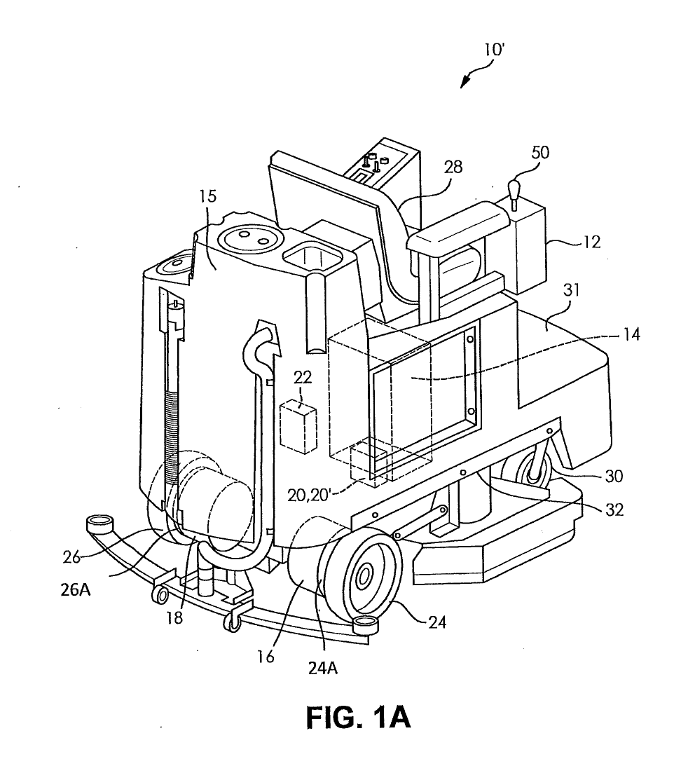

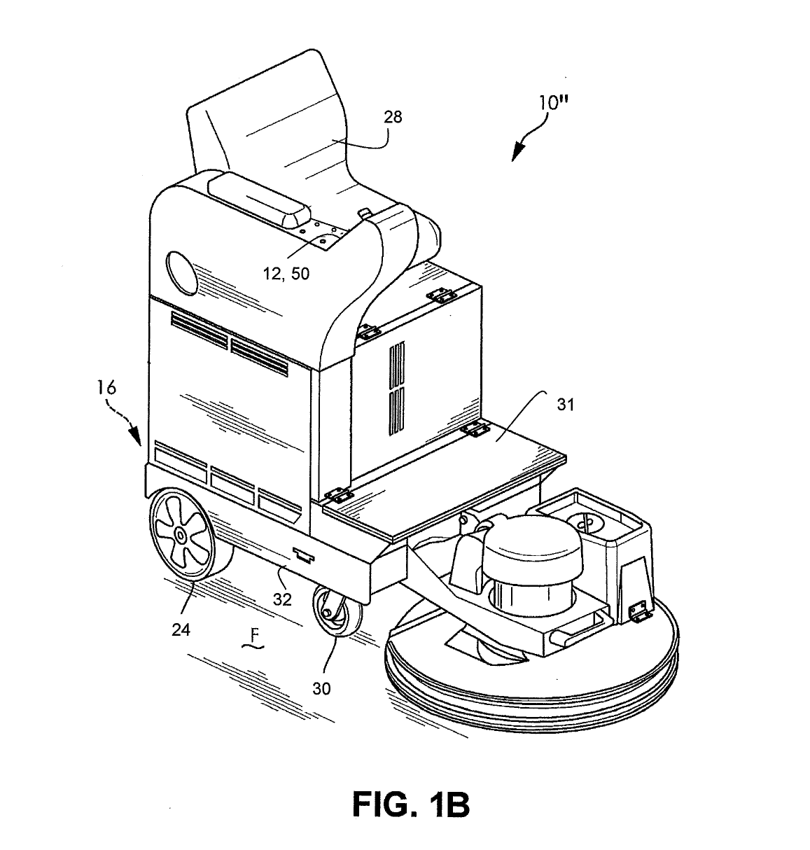

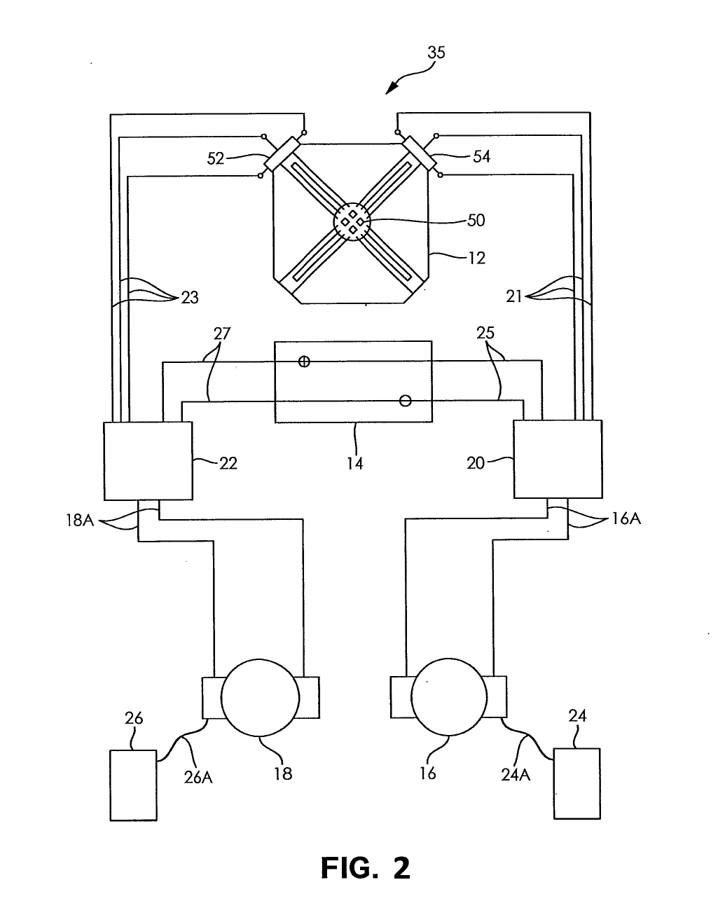

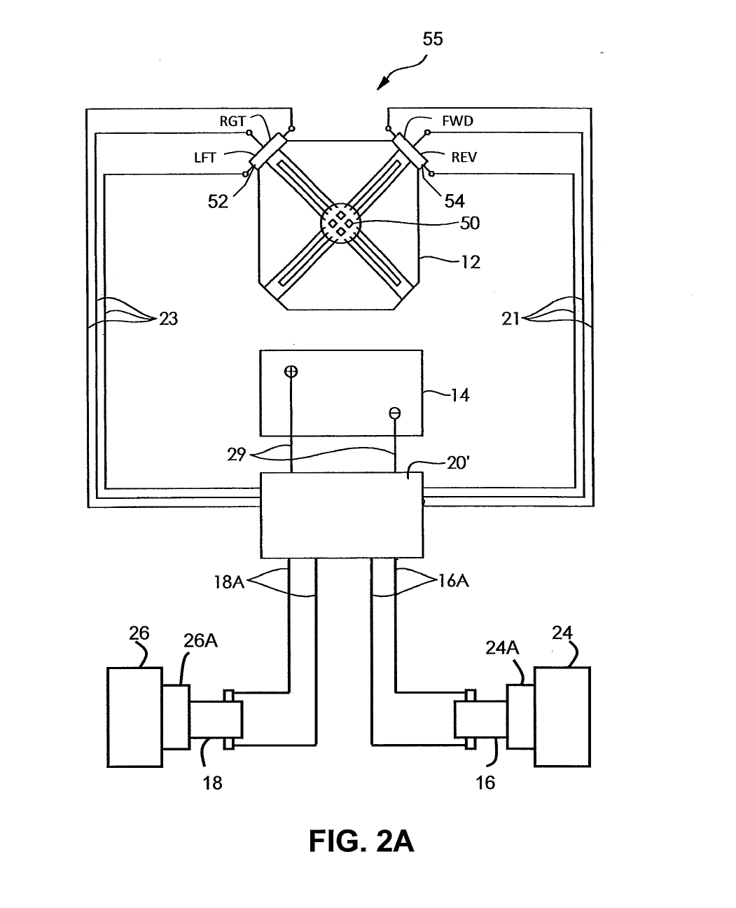

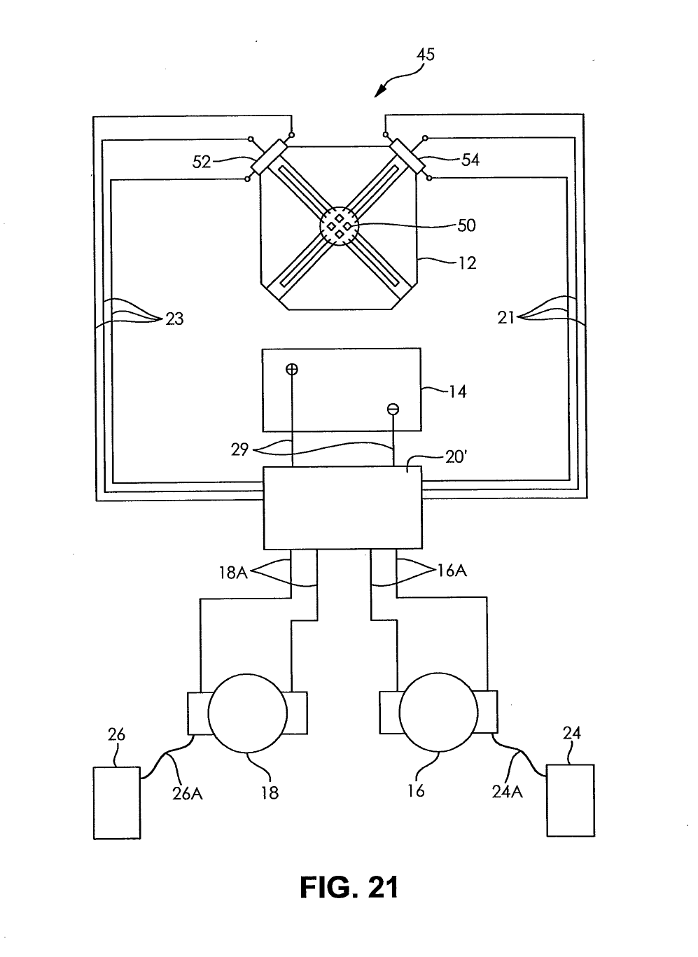

FIG. 1 illustrates a ride-on floor cleaning/burnishing machine 10 having a pointing device control 12, an onboard electric power source 14, at least one cleaning tank 15, right and left electrical drive motors 16, 18, right and left motor controller portions 20, 22 or a single motor controller 20′ (see FIGS. 2, 2A, 21) that control both right and left motors 16, 18, and right and left rear steering drive wheels 24, 26. The ride-on floor cleaning/burnishing machine 10 may utilize the cleaning tank 15 to clean or burnish a floor F.

Also shown in FIG. 1 are a seat 28, where an operator of the floor cleaning/burnishing machine 10 sits while operating the machine 10, and at least one caster 30 that aids in maneuvering and supporting a frame 32 of the machine 10 above the floor F. A platform 31, which extends toward the front of the machine 10 from below the seat 28, is provided for resting the operator's feet as the operator controls the machine 10. Except for the drive wheels 24, 26 and caster 30, all other items are supported by the frame 32.

FIG. 2 is an electrical schematic of a first embodiment 35 of the present invention, where the motor controllers 20, 22 are separately connected through individual electrical communication lines 21, 23 with respectively right and left software driven motor control logic units 54, 52 of the pointing device control 12. The motor controllers 20, 22 are also separately connected through individual electrical communication lines 25, 27 with the onboard electrical power source 14. The right electrical drive motor 16 is in separate electrical communication, by way of right motor control lines 16A, with the right motor controller 20.

The right electrical drive motor 16 is in mechanical communication, by way of right mechanical linkage 24A, which may be, for example, a direct drive mechanism 24A for a ride-on floor cleaning/burnishing machine 10′ as shown in FIG. 1A or a belt drive and pulley as shown in FIG. 1, with the right rear steering drive wheel 24. The left electrical drive motor 18 is in separate electrical communication, by way of left motor control lines 18A, with the left motor controller 22. The left electrical drive motor 18 is in mechanical communication, by way of left mechanical linkage 26A or left direct drive mechanism 26A, with the left rear steering drive wheel 26 (as shown in FIG. 1A). Hence, the velocity (i.e., speed in a forward or reverse direction) and the direction of rotation of each rear steering drive wheel 24, 26 are separately controlled by the corresponding motor controller 20, 22, via the pointing device control 12 and right and left software driven motor control logic units 54, 52, independent of the other drive wheel 24, 26, for precise movement and steering control of the floor cleaning machines 10 10′ across the floor F.

Similarly, FIG. 21 is an electrical schematic of a second embodiment 45 of the present invention, where a single motor controller 20′ (which may be the motor controller 20, as seen in FIG. 2, with the two (2) separate sets of motor control lines 16A, 18A and separate electrical communication lines 21, 23) may be used in place of two (2) separate motor controllers 20, 22. The single motor controller 20′ is separately electrically connected through individual electrical communication lines 23, 21 with respectively right and left software driven motor control logic units 54, 52 of the pointing device control 12, and is separately electrically connected to electrical communication lines 29 with the onboard electrical power source 14. Hence, the right and left electrical drive motors 16, 18 are still in separate electrical communication, by way of corresponding motor control lines 16A, 18A, with the common motor controller 20′. As noted above, the first and second embodiments 35, 45, are respectively logically controlled by software within a pointing device control 12 that individually controls right and left driven motor units 52, 54, by way of a control device 50, which may be a joystick, as illustrated in FIGS. 1 and 1A.

FIG. 2A, on the other hand, illustrates a third embodiment 55, wherein the driven motor unit 52 is logically controlled by the software as having a right (RGT) portion and a left (LFT) portion of the joystick 50, whereas the driven motor unit 54 is logically controlled by the software as having a forward (FWD) portion and a reverse (REV) portions of, for example, the joystick 50. It has been found that in logically controlling the ride-on floor cleaning/burnishing machines 10, 10′, by the means of the third embodiment 55, the present invention is afforded more precise control of the ride-on floor cleaning/burnishing machines 10, 10′. Although the joy stick 50 is not specifically indicated in FIG. 1B for a ride-on floor cleaning/burnishing machine 10″, the above stated embodiments 35, 45, 55 do equally apply to the ride-on floor cleaning/burnishing machine 10″.

Further, the third embodiment 55 is similar to the second embodiment 45 but where there is only a single motor controller 20′ (which may be the motor controller 20, as seen in FIG. 2) in place of the separate motor controllers 20, 22. Also, the single motor controller 20′ is separately electrically connected to the electrical communication line 29 with the onboard electrical power source 14. However, the right and left electrical drive motors 16, 18 are respectively mechanically linked to the wheels 16, 18 by way of the direct drive mechanisms 24A, 26A, as FIG. 1A three dimensionally illustrates. Hence, the wheels 24, 26 are respectively driven by the direct drive mechanisms 24A, 26A.

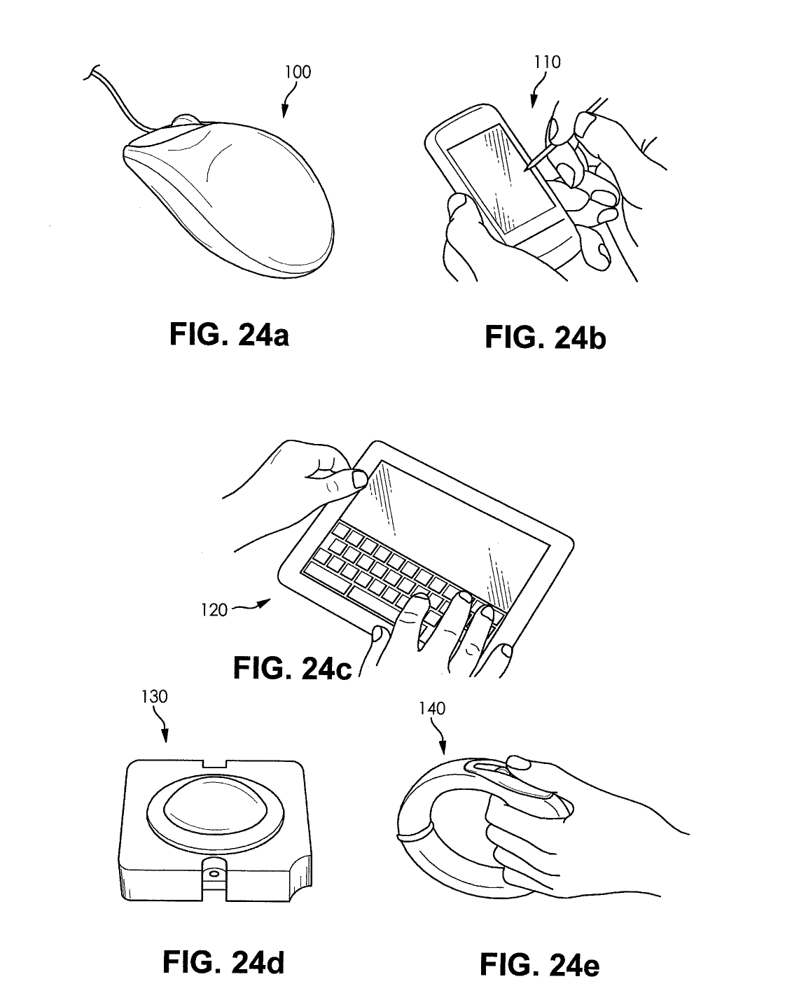

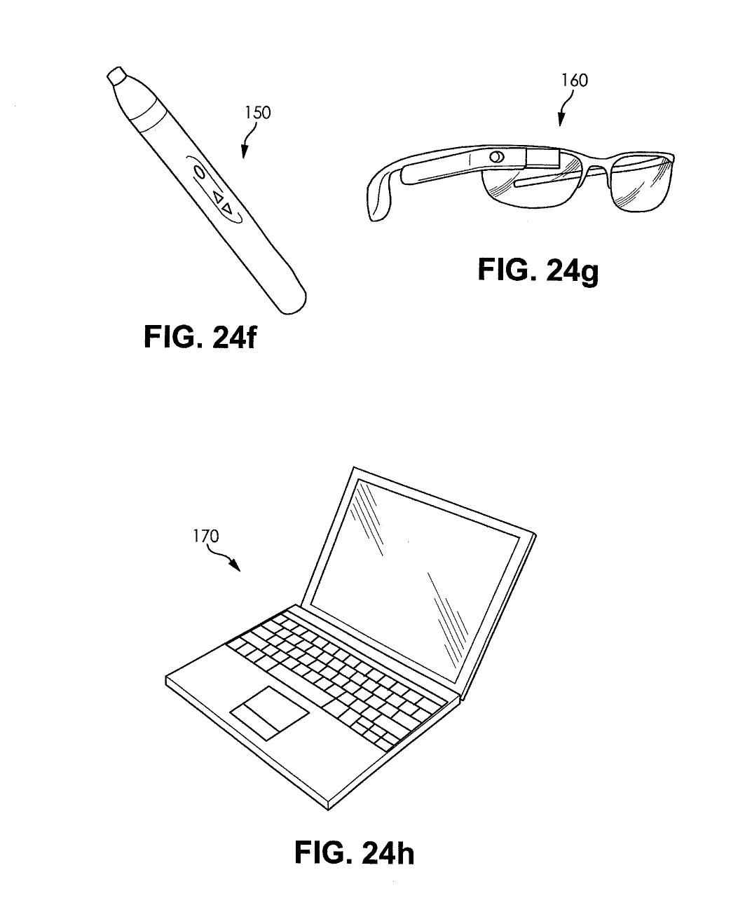

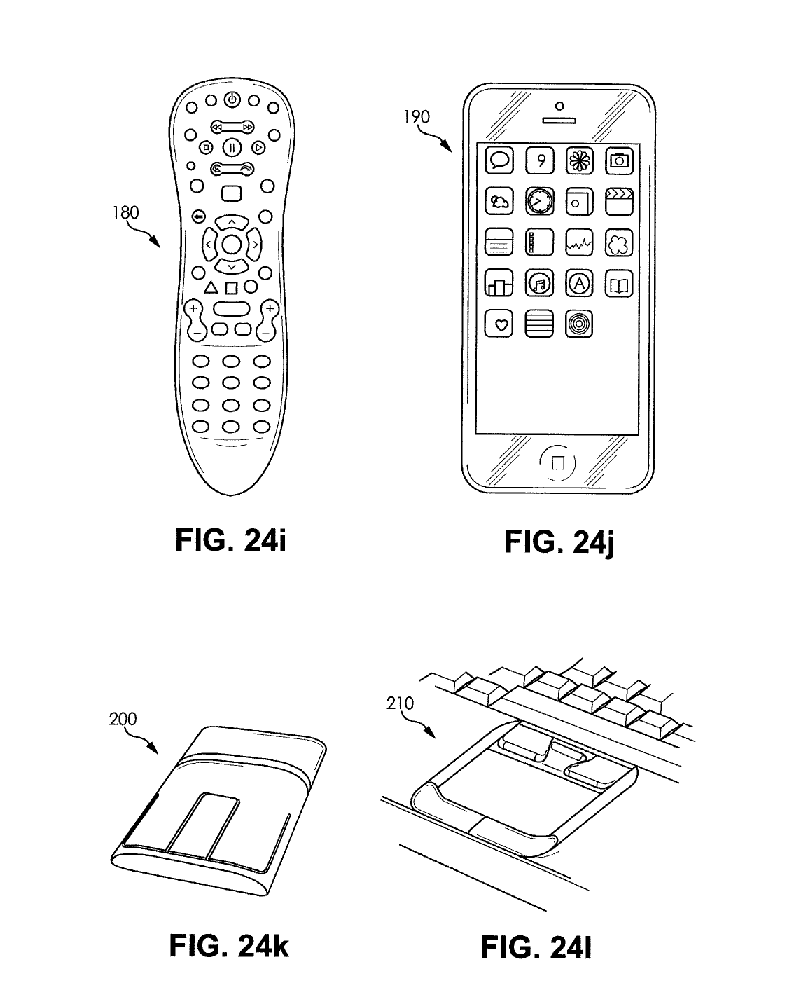

In addition to the joystick being utilized as a control device 50, the devices 100, 110, 120, 130, 140, 150, 160, 170, 180, 190, 200, 210 (i.e., 100-210) which are listed herebelow, with other potential pointing devices, in the Table of Pointing Devices and illustrated in FIGS. 24a-24l, are input control devices 50 that interact with the software within the pointing device control 12. The present invention, however, is not limited to only the pointing devices illustrated or listed in this application.

TABLE OF POINTING DEVICES

| | |
|---|---|
| Mouse | Stylus with touch screen |
| Control buttons and scroll wheel | Tablet with virtual keyboard |
| Trackball | Hand held remote control ring |
| Light pen | Google glasses wireless RF device |
| Laptop computer with keyboard | Remote RF controller |
| Touch pad cell phone | Button direction device |
| Smartphone | Blue tooth wireless mouse |
| Control buttons and scroll buttons | Ring of light sensors |
| Thumb pointing device | iPod, iPad, iPhone |
| Bluetooth devices | Computer PC, Mac |

Consequently, all of the devices 100-210 illustrated in FIGS. 24a-24l logically interact with the software within the pointing device control 12 and are utilized in anyone of the three embodiments 35, 45, 55 of the present invention.

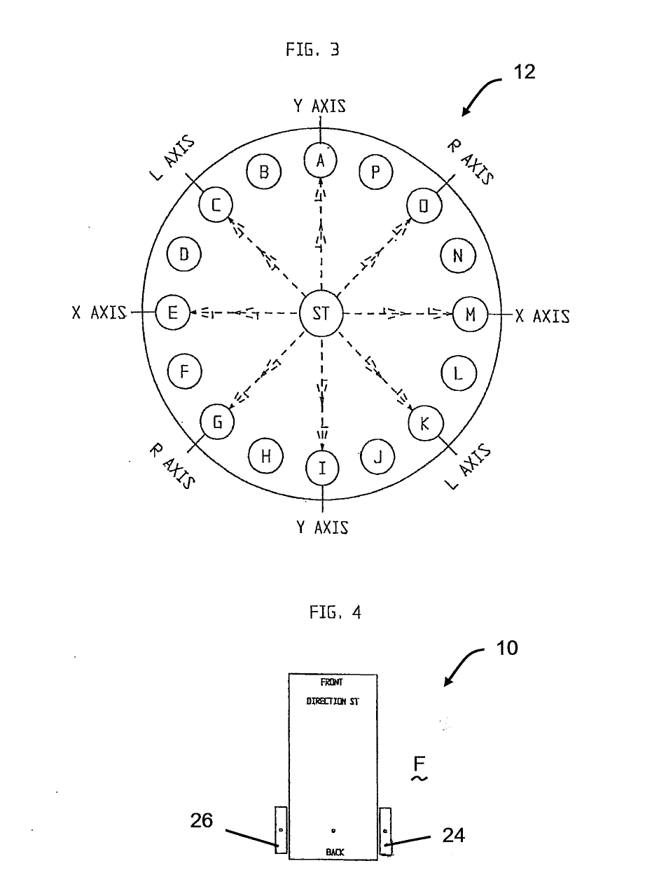

As a result, in either of the first, second, or third embodiments 35, 45, 55, the floor cleaning machines 10, 10′, 10″ are easy and simple to drive by the operator who moves a pointing device 50, as depicted in FIGS. 1, 1A, 1B, 2, 2 A, 21, and 24a-24l with various combinations of fore and aft and side-to-side motion, which is specifically described in detail below. The floor cleaning machines 10, 10′, 10″ can be steered at various speeds (where direction and speed comprise velocity) and with various radii of curvature on the floor or even pivoted in one spot, as illustrated in FIGS. 3-20. Therefore, precise steering control of the floor cleaning machines 10, 10′, 10″, across the floor F, is provided by the present invention. This steering could be realized by pointing the light pen 150 in the direction that the operator chooses to move the floor cleaning machines 10, 10′, 10″. Or further, the operator could even steer without the use of the hands, where, for example, the Google glass pointing device of FIG. 24g could be programmed to steer the floor cleaning/burnishing machines 10, 10′, 10″ by sight.

Further, the various devices 100, 110, 120, 130, 140, 150, 160, 170, 180, 190, 200, 210, allow an operator to use a single hand, eye sight, verbal commands, tilt of a body part, other body signals, and/or computer commands or, for example, on-board or remote live stylus commands, to navigate straight-out areas or even in tight areas to clean or burnish, and around obstacles, all the while reducing or eliminating operator fatigue or an operator all together. In essence, the devices 100-210 enable the floor cleaning/burnishing machines 10, 10′, 10″ to be operated remotely robotically.

The floor cleaning machines 10, 10′, 10″ are in contrast to those conventional floor cleaning machines that may only control the lineal speed where, at any given time, the conventional floor cleaning machines wheels rotate in the same radial direction and steering is controlled by other means than that of the present invention. Hence, at any given time, such conventional floor cleaning machines, like the Mayer apparatus, would be limited to a single pivot point around the wheels because this conventional machine's wheels are not designed to be controlled to rotate in opposite directions at the same time, as those drive wheels 24, 26 of the present invention.

More specifically, FIGS. 2, 21, 2A illustrate that the onboard electrical power source 14, which is typically a direct current battery pack, supplies electrical power to the left motor controller 22, the right motor controller 20, or the common controller 20′. Thus, anyone of the pointing devices 50 is capable of 360 degrees of motion control, thereby electrically connecting the respective software driven motor control logic units 52, 54 to their corresponding drive motors 18, 16, where each software driven motor control logic unit 52, 54 could reside within the pointing device control 12. Specifically as a joy stick, the pointing device 50 is mounted at a 45 degree angle from the X and Y axes and 90 degrees from each of the other axes as shown as L and R axes in FIG. 3. With this combination of X and Y, and L and R axes, the selection of speed and direction of rotation afforded the two drive wheels 24, 26 is nearly limitless. This precise functionality is duplicated in software for all of the other pointing devices 50 that are illustrated as items 100-210 in FIGS. 24a-24l.

In general, the floor cleaning or burnishing machines 10, 10′, 10″ have at least one motor 20, 20′, 22 controller that is electrically connected to the pointing device 50, individual right and left software driven motor control logic units 54, 52, the onboard electrical power source 14, and individual right and left electrical drive motors 16, 18. The right drive motor 16 is mechanically connected to the right rear steering drive wheel 24 and the left electrical drive motor 18 is mechanically connected to the left rear steering drive wheel 26. Rotational speed and direction of each rear steering drive wheel 24, 26 is independently controlled, by way of the pointing device 50 in cooperation with respective right and left software driven motor control logic units 54, 52, in either a forward or reverse direction. At any given time, each software driven motor control logic unit 54, 52 controls a respective motor controller 20, 20′, 22 which individually controls the rotational speed and direction of a respective drive wheel 24, 26, thereby each drive wheel 24, 26 is capable of rotating in an opposite direction at a different speed to the other drive wheel 26, 24.

For either embodiment illustrated in FIG. 2, 2A, or 21, the floor cleaning machines 10, 10′, 10″ may operate in a wig-wag (known as center-off) configuration meaning that the software driven motor control logic units 52, 54 control both speed and direction of the drive motors 16, 18. When the pointing device 50 is in the center position (i.e., direction) the software driven pointing device pointing device 50 is caused to be in an off position ST. Hence, when the pointing device 50 causes the floor cleaning or burnishing machines 10, 10′, 10″ to move and then to be released from movement, then the pointing device 50 will always be returned to the off position ST.

FIG. 22 illustrates the logical operation of the motors 16, 18 in either a “motor” mode or in a “generator” mode. When the pointing device 50 is in the ST position, the motors 16, 18 are operated in the “generator” mode. When the pointing device 50 is not in the ST position, the motors 16, 18 are operated in the “motor” mode. Quite simply, in operating the motors 16, 18 in the “generator” mode, the motors 16, 18 become electrical generators whose output is then mechanically applied to the wheels 24, 26 in reverse, in order to slow down (i.e., apply brakes to) the wheels 24, 26. This form of braking is known as regenerative braking. In operating the motors 16, 18 in the “motor” mode, the motors 16, 18 are electrically operated as motors whose mechanical output is then mechanically applied to the wheels 24, 26 in order to drive the wheels 16, 18.

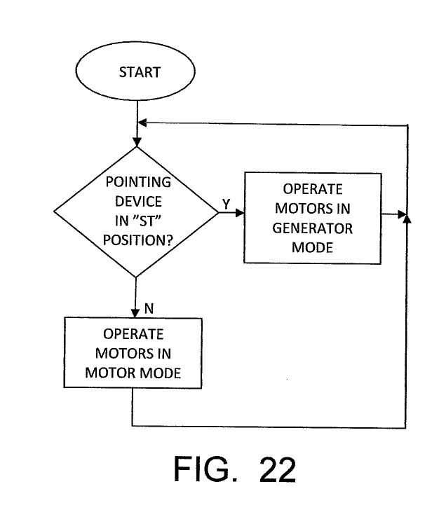

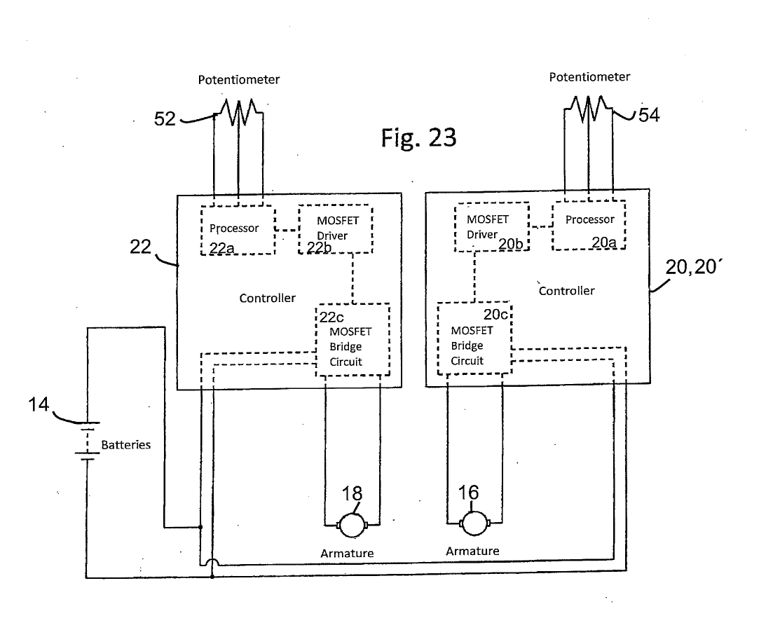

FIG. 23 illustrates that each (right, left) of the controllers 20, 22 internally comprises a processor 20a, 22a, a MOSFET driver 20b, 22b, and a MOSFET bridge circuit 20c, 22c, which are correspondingly connected to the right and left software driven motor control logic units 54, 52, onboard power source 14 (e.g., batteries), and electrical drive motors 16, 18.

Referring to FIG. 3, as the pointing device 50 (e.g., the control lever of the joy stick 50) is caused to move away from the center position ST, the software driven motor control logic units 52, 54 will signal movement from the center unless the pointing device 50 moves along the L or R axis, in which case the software driven motor control logic units 52 or 54 connected to the L or R axis will not signal movement to the wheels 24, 26. With this arrangement, the movement of the pointing device 50 in conjunction with the pointing device control 12 can move each software driven motor control logic unit 52, 54 independently, producing separate output signals that determine a selected drive wheel speed and at the same time a selected drive wheel direction of rotation for each drive motor 16, 18. The motor controllers 20, 22 interpret the analog signals from the pointing device control 12 and transforms the supplied battery voltage and polarity (shown as (+) and (−) on the onboard power source 14 in FIGS. 2 and 21) into the electrical current needed to move the left rear drive motor 18 and right rear drive motor 16, coupled to the corresponding drive wheels 26, 24 at independent speeds and rotational directions for moving the floor cleaning machines 10, 10′, 10″.

Accordingly, the two rotational directions (fore and aft) of the drive wheels 26, 24 may be different. The same above-described function of the pointing device 50 takes place with the single motor controller 20′, as shown in FIG. 21, which replaces the two separate motor controllers 20, 22, while retaining the separate corresponding sets of motor control lines 16A, 18A.

Specifically, the pointing device control 12, as detailed in FIGS. 2 and 21, associates a position (that is typically a logical position within the pointing device control 12 except, for example, for a joy stick, which would actually be a physical position) of the pointing device 50 with the direction of movement of the independent drive wheels 24, 26 for maneuvering the floor cleaning machines 10, 10′, 10″. The floor cleaning machines 10, 10′, 10″ will move in relationship to the position/direction that the pointing device 50 is pointing at a speed in relationship to how far from the center position ST it moves, as shown in FIG. 3.

As a result of the pointing device control 12, the floor cleaning machines 10, 10′, 10″ are very maneuverable by allowing movement in any direction, at any speed, which includes rotating the drive wheels in opposite radial directions at the same time. This is achieved by utilizing the movement of the pointing device 50 in respect to the X and Y axes in combination with the L and R axes, as also shown in FIG. 3. The following are the specifics associated with each of the positions/directions A-P and ST of the pointing device control 12 that are detailed for the X, Y, R, and L axes and halfway between these positions. In reality, there are an infinite number of positions within the 360° that are available for the pointing device 50 to span. It is noteworthy that the X and Y axes in combination with the L and R axes, as illustrated above in FIG. 3, shows the movement or non-movement of the floor cleaning machines 10, 10′, 10″ over the floor F for FIG. 4 and is applied to the subsequent FIGS. 5-20, as it applies to these axes X, Y, L, R.

Regarding position ST, when the pointing device 50 is in the center position/direction ST, the floor cleaning machines 10, 10′, 10″ are stopped or at rest (see FIG. 4). The left and right drive wheels 26, 24 receive no voltage or polarity signal via motor control lines 18A, 16A from the pointing device control 12. The floor cleaning machines 10, 10′, 10″ will not move until the pointing device 50 is moved in the direction the operator chooses for the floor cleaning machines 10, 10′, 10″ to go.

Regarding direction A, when the pointing device 50 moves straight forward (as seen by the arrow pointing up between the two images of the machines 10, 10′, 10″ in FIG. 5) away from the center along the Y axis in a positive direction, both drive wheels 24, 26 of the floor cleaning machines 10, 10′, 10″ begin to rotate slowly in the same direction moving the floor cleaning machines 10, 10′, 10″ in a straight forward direction A. As the position of the pointing device 50 moves farther away from the center along the Y axis, the rotation of the drive wheels 24, 26 will increase. Thus, the machines 10, 10′, 10″ will increase in speed in a straight forward direction A.

Regarding direction I, when the pointing device 50 moves straight backward away (see arrow pointing down between the two images of the machines 10, 10′, 10″ in FIG. 6) from the center along the Y axis in a negative direction both drive wheels 24, 26 of the floor cleaning machines 10, 10′, 10″ begin to rotate slowly in the same direction moving the floor cleaning machines 10, 10′, 10″ in a straight reverse direction I. As the position of the pointing device 50 moves farther away from the center along the Y axis in a negative direction, the rotation of the drive wheels 24, 26 will increase. Thus, the machines 10, 10′, 10″ will increase in speed in a straight reverse direction I.

Regarding direction M, when the pointing device 50 moves away from the center along the X axis in a positive direction the left drive wheel 26 will rotate in a forward direction and the right drive wheel 24 will rotate in a reverse direction, both at equal speeds, causing the floor cleaning machines 10, 10′, 10″ to pivot to the right around the center distance between the left and right drive 26, 24 (see clockwise arrow pointing down in FIG. 7, direction M), thereby the left and right drive wheels 26, 24 swap positions, that is where each rear wheel 26, 24 takes the position of the other rear wheel 24, 26 in a 180 degree turn. As the position of the pointing device 50 moves farther away from the center along the X axis in a positive direction, the rotation of the drive wheels 24, 26 will increase. Thus, the floor cleaning machines 10, 10′, 10″ will increase in speed rotating right in direction M.

Regarding direction E, when the pointing device 50 moves away from the center along the X axis in a negative direction the left drive wheel 26 will rotate in a reverse direction and the right drive wheel 24 will rotate in a forward direction, both at equal speeds, causing the floor cleaning machines 10, 10′, 10″ to pivot to the left around the center distance between the left and right drive wheels 26, 24 (see counterclockwise arrow in FIG. 8, direction E), thereby the left and right drive wheels 26, 24 swap positions. As the position of the pointing device 50 moves farther away from the center along the X axis in a negative direction, the rotation of the drive wheels 24, 26 will increase. Thus, the machines 10, 10′, 10″ will increase in speed rotating left in direction E.

Regarding direction C, when the pointing device 50 moves away from the center along the L axis in a positive direction the left drive wheel 26 is stopped and the right drive wheel 24 will be moving in a forward direction. The floor cleaning machines 10, 10′, 10″ will pivot in position to the left on the center of the left drive wheel 26 (see counterclockwise arrow in FIG. 9, direction C), where the left rear steering drive wheel 26 is capable of remaining in a pivot position. As the position of the pointing device 50 moves farther away from the center along the L axis in a positive direction, the rotational speed of the right drive wheel 24 will increase. Thus, the machines 10, 10′, 10″ will increase in speed rotating to the left in direction C.

Regarding direction K, when the pointing device 50 moves away from the center along the L axis in a negative direction the left drive wheel 26 is stopped and the right drive wheel 24 will be moving in a reverse direction. The floor cleaning machines 10, 10′, 10″ will pivot in position to the right on the center of the left drive wheel 26 (see arrow in a clockwise direction in FIG. 10, direction K), where the left rear steering drive wheel 26 is capable of remaining in a pivot position. As the position of the pointing device 50 moves farther away from the center along the L axis in a negative direction, the rotational speed of the right drive wheel 24 will increase. Thus, the machines 10, 10′, 10″ will increase in speed rotating to the right in direction K.

Regarding direction O, when the pointing device 50 moves away from the center along the R axis in a positive direction the right drive wheel 24 is stopped and the left drive wheel 26 will be moving in a forward direction. The floor cleaning machines 10, 10′, 10″ will pivot in position to the right on the center of the right drive wheel 24 (see arrow in a clockwise direction in FIG. 11, direction O), where the right rear steering drive wheel 24 is capable of remaining in a pivot position. As the position of the pointing device 50 moves farther away from the center along the R axis in a positive direction, the rotational speed of the left drive wheel 26 will increase. Thus, the machines 10, 10′, 10″ will increase in speed rotating to the right in direction O about the right rear steering drive wheel 24.

Regarding direction G, when the pointing device 50 moves away from the center along the R axis in a negative direction the right drive wheel 24 is stopped and the left drive wheel 26 will be moving in a reverse direction. The floor cleaning machines 10, 10′, 10″ will pivot in position to the left on the center of the right drive wheel 24 (see arrow in a counterclockwise direction in FIG. 12, direction G), where the right rear steering drive wheel 24 is capable of remaining in a pivot position. As the position of the pointing device 50 moves farther away from the center along the R axis in a negative direction, the rotational speed of the left drive wheel 26 will increase. Thus, the machines 10, 10′, 10″ will increase in speed rotating to the left in direction G.

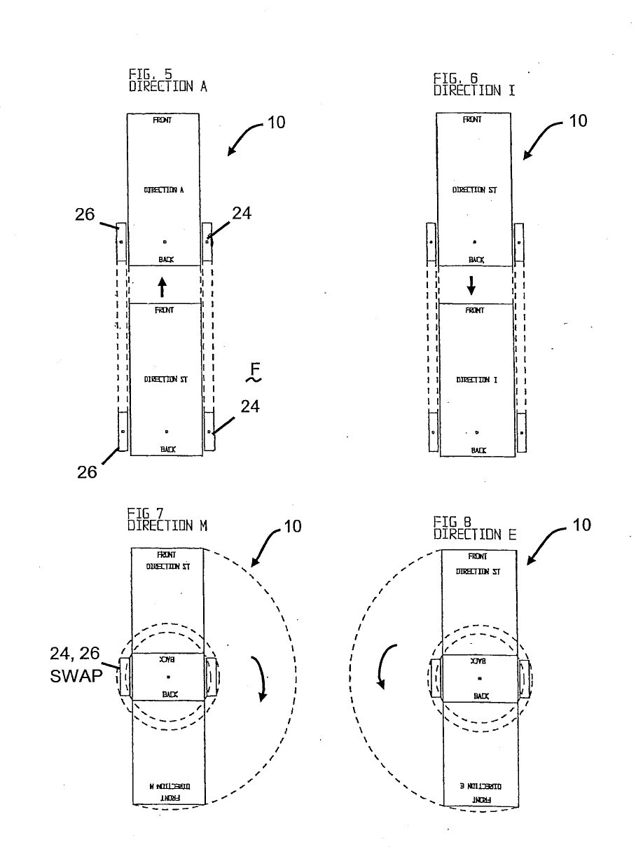

Regarding direction B, as the pointing device 50 is positioned between the Y axis in a negative direction and the L axis in a positive direction, the inside turning left drive wheel 26 is rotating in a forward direction slower than the outside turning right drive wheel 24 in a forward direction, causing the floor cleaning machines 10, 10′, 10″ to turn to the left while moving forward (see arrow veering toward the top left in FIG. 13, direction B). As the position of the pointing device 50 moves around between the Y axis and the L axis, the rotational speed of the wheels 24, 26 will change respectively controlling how sharp the machines 10, 10′, 10″ turns to the left while moving forward in direction B.

Regarding direction P, as the pointing device 50 is positioned between the Y axis in a positive direction and the R axis in a positive direction, the inside turning right drive wheel 24 is rotating in a forward direction slower than the outside turning left drive wheel 26 in a forward direction, causing the floor cleaning machines 10, 10′, 10″ to turn to the right while moving forward (see arrow veering toward the top right FIG. 14, direction P). As the position of the pointing device 50 moves around between the Y axis and the R axis, the rotational speed of the wheels 24, 26 will change respectively controlling how sharp the machines 10, 10′, 10″ turns to the right while moving forward in direction P.

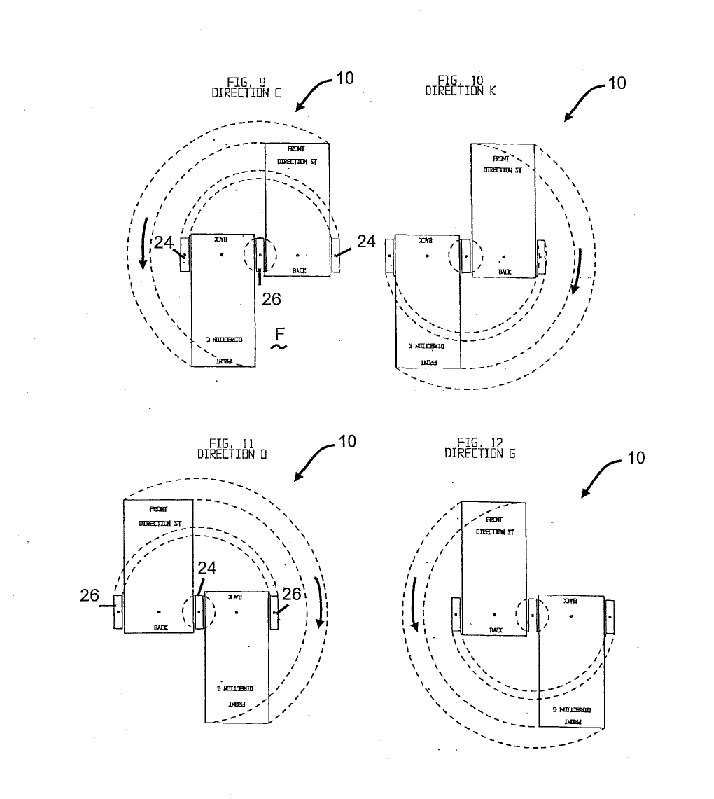

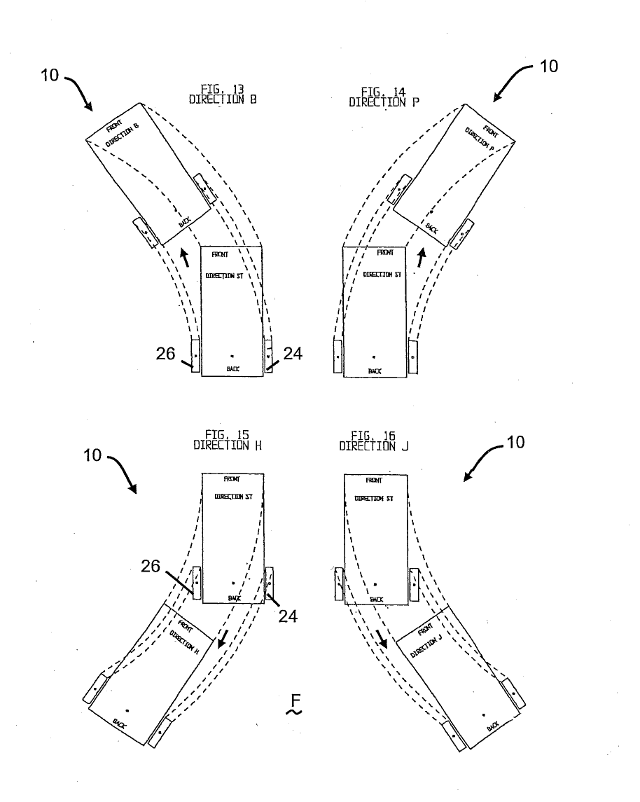

Regarding direction H, as the pointing device 50 is positioned between the Y axis in a negative direction and the R axis in a negative direction, the inside turning left drive wheel 26 is rotating in a reverse direction slower than the outside turning right drive wheel 24 in a reverse direction causing the floor cleaning machines 10, 10′, 10″ to turn to the left while moving backward (see arrow veering toward the bottom left in FIG. 15, direction H). As the position of the pointing device 50 moves around between the Y axis and the R axis, the rotational speed of the wheels 24, 26 will change respectively controlling how sharp the machines 10, 10′, 10″ turns to the left while moving backward in direction H.

Regarding direction J, as the pointing device 50 is positioned between the Y axis in a positive direction and the R axis in a negative direction, the inside turning right drive wheel 24 is rotating in a reverse direction slower than the left drive wheel 26 in a reverse direction causing the floor cleaning machines 10, 10′, 10″ to turn to the right while moving backward (see arrow veering toward the bottom right in FIG. 16, direction J). As the position of the pointing device 50 moves around between the Y axis and the L axis, the rotational speed of the wheels 24, 26 will change respectively controlling how sharp the machines 10, 10′, 10″ turns to the right while moving backward in direction J.

Regarding direction D, as the pointing device 50 is positioned between the X axis in a positive direction and the L axis in a negative direction, the left drive wheel 26 is rotating in a reverse direction slower than the right drive wheel 24 in a forward direction causing the floor cleaning machines 10, 10′, 10″ to turn on an axis between the center of the left drive wheel 26 and the center between both drive wheels 24, 26 allowing the floor cleaning machines 10, 10′, 10″ to make a tight turn to the left (see arrow in a counterclockwise direction in FIG. 17, direction D). As the position of the pointing device 50 moves around between the Y axis and the L axis, the rotational speed of the wheels 24, 26 of the floor cleaning machines 10, 10′, 10″ will change respectively controlling how sharp the floor cleaning machines 10, 10′, 10″ rotates or turns to the left in direction D.

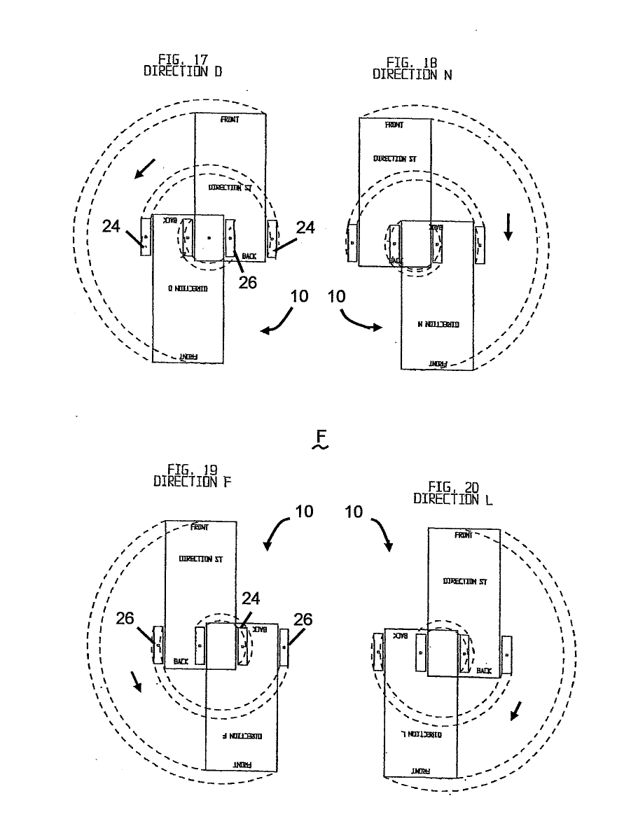

Regarding direction N, as the pointing device 50 is positioned between the X axis in a positive direction and the R axis in a negative direction, the left drive wheel 26 is rotating in a forward direction faster than the right drive wheel 24 in a reverse direction causing the floor cleaning machines 10, 10′, 10″ to turn on an axis between the center of the right drive wheel 24 and the center between both drive wheels 24, 26 allowing the floor cleaning machines 10, 10′, 10″ to make a tight turn to the right (see arrow in a clockwise direction in FIG. 18, direction N). As the position of the pointing device 50 moves around between the X axis and the R axis, the rotational speed of the wheels 24, 26 will change respectively controlling how sharp the machines 10, 10′, 10″ rotates or turns to the right direction N.

Regarding direction F, as the pointing device 50 is positioned between the X axis in a negative direction and the R axis in a positive direction, the right drive wheel 24 is rotating in a forward direction slower than the left drive wheel 26 in a reverse direction causing the floor cleaning machines 10, 10′, 10″ to turn to the left on an axis between the center of the right drive wheel 24 and the center between both drive wheels 24, 26 allowing the floor cleaning machines 10, 10′, 10″ to make a tight turn to the left (see arrow in a counterclockwise direction in FIG. 19, direction F). As the position of the pointing device 50 moves around between the X axis and the R axis, the rotational speed of the wheels 24, 26 will change respectively controlling how sharp the machines 10, 10′, 10″ rotates or turns to the left in direction F.

Regarding direction L, as the pointing device 50 is positioned between the X axis in a negative direction and the L axis in a positive direction, the left drive wheel 26 is rotating in a forward direction slower than the right drive wheel 24 in a reverse direction causing the floor cleaning machines 10, 10′, 10″ to turn on an axis between the center of the right drive wheel 24 and the center between both drive wheels 24, 26 allowing the floor cleaning machines 10, 10′, 10″ to make a tight turn to the right (see arrow in a clockwise direction in FIG. 20, direction L). As the position of the pointing device 50 moves around between the X axis and the L axis, the rotational speed of the wheels 24, 26 will change respectively controlling how sharp the machines 10, 10′, 10″ rotates or turns to the right in direction L.

As can be seen from the above description, the floor cleaning/burnishing machines 10, 10′, 10″ more accurately control the speed and steering of a ride-on, battery operated floor cleaning/burnishing machines 10, 10′, 10″ than conventional floor cleaning machines, thereby saving operator time and cleaning chemical costs. As a result, the floor cleaning/burnishing machines 10, 10′, 10″ are more precise in maneuvering and navigation across a floor F, in tight situations, and around objects. These machines 10, 10′, 10″, in conjunction with the joystick 50 and the various devices 100, 110, 120, 130, 140, 150, 160, 170, 180, 190, 200, 210, allow an operator to use a single hand, eye sight, verbal commands, tilt of a body part, other body signals, and/or pre-scripted computer commands or, for example, on-board or remote live stylus commands, to navigate straight-out areas or even in tight areas to clean or burnish, and around obstacles, all the while reducing or eliminating operator fatigue or an operator all together.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A floor cleaning or burnishing machine, comprising:
a pointing device control;
a pointing device selected from the group consisting of a mouse, a stylus with a touch screen, control buttons and a scroll wheel, a tablet with a virtual keyboard, a trackball, a hand held remote control ring, a light pen, a Google glass, a wireless RF device, a laptop computer with keyboard, a touch pad cell phone, a button direction device, and a blue tooth wireless mouse, wherein the pointing device is controlled by the pointing device control;
a right motor control logic unit controlled by the pointing device control and having three right communication lines and a left motor control unit having three left communication lines;
at least one motor controller electrically powered by an onboard electrical power source and separately in electrical communications with the three right communication lines and the three left communication lines;
a right electrical motor in mechanical communication with a right mechanical linkage and a left electrical motor in mechanical communication with a left mechanical linkage; and
a right rear steering drive wheel mechanically driven by the right mechanical linkage and a left rear steering drive wheel being separately mechanically driven by the left mechanical linkage;
wherein rotational speed and forward and reverse direction of the right rear steering drive wheel is independent of the rotational speed and forward and reverse direction of left rear drive wheel, on a floor to be cleaned.

2. The floor cleaning machine or burnishing machine of claim 1, wherein the at least one motor controller comprises a separate right motor controller being individually electrically connected to the right motor control logic unit and further comprises a separate left motor controller being individually electrically connected to the left motor control logic unit.

3. The floor cleaning machine or burnishing machine of claim 2, wherein each of the right and left motor controllers comprises a processor electrically connected internally to a MOSFET driver that in turn is electrically connected internally to a MOSFET bridge circuit that in turn is electrically connected externally to the respective right and left electrical drive motor.

4. The floor cleaning machine or burnishing machine of claim 1, wherein the pointing device has an ST position where each of the right and left electrical drive motors are a regenerative brake and the pointing device has any other position where the right and left electrical drive motors are rotationally mechanically connected to their respective rear steering drive wheel.

5. The floor cleaning machine or burnishing machine of claim 1, wherein each of the right and left mechanical linkages comprises a belt drive and pulley.

6. The floor cleaning machine or burnishing machine of claim 1, wherein each of the right and left mechanical linkages comprises a direct drive mechanism.

7. The floor cleaning machine or burnishing machine of claim 1, wherein each rear steering drive wheel is capable of being in the other rear wheel position after a 180 degree turn.

8. The floor cleaning machine or burnishing machine of claim 1, wherein each of the rear steering drive wheels is capable of remaining in a pivot position.

9. The floor cleaning machine or burnishing machine of claim 1, wherein the pointing device is in remote robotic computer communication with a floor cleaning/burnishing machine.

10. The floor cleaning machine or burnishing machine of claim 1, wherein the right motor control logic unit is logically controlled by software having a right (RGT) portion and a left (LFT) portion and the left motor logic unit is logically controlled by software having a forward (FWD) portion and a reverse (REV) portion.
